(19) United States
(12) Patent Application Publication
(10) Pub. No.: US 2011/0058815 A1
(43) Pub. Date: Mar. 10, 2011

(54) Oceanic communications system

(76) Inventor: Brett A. Plentl, Colorado Springs, CO (US)

(21) Appl. No.: 12/875,645

(22) Filed: Sep. 3, 2010

Related U.S. Application Data
(60) Provisional application No. 61/240,840, filed on Sep. 9, 2009.

(51) Int. Cl. H04B 10/00

(52) U.S. Cl. 398/115

(57) ABSTRACT

A system of buoys is connected by vertical cables to submarine fiber optic communications cable on the ocean floor or in cases where no submarine fiber optic cable is present, the buoys will use satellite communication. The buoys are aligned on the surface of the ocean, underneath heavily traveled oceanic air routes to provide platforms for radios. The satellite or cable connection to the buoys enables high bandwidth communications backhaul from the buoy to the internet or public switched telephone network. The high bandwidth buoys provide a platform to put different radio systems, enabling a substantially uninterrupted radio connection to high altitude aircraft as they transit oceanic airspace.

### CROSS-REFERENCE TO RELATED APPLICATION

The present application is based on and claims the benefit of U.S. provisional patent application Ser. No. 60/240,840, filed Sep. 9, 2009, the content of which is hereby incorporated by reference in its entirety.

### BACKGROUND OF THE INVENTION

The present invention is in the technical field of communications. More particularly, the present invention is in the technical field of ocean-based communications.

Current ocean-based communications systems, such as submarine fiber optic cable, do not offer data paths to the surface of the ocean, except at the cable landing stations. Aircraft or ships transiting the ocean are dependent on satellite-based communications systems, even though the routes they fly or sail often approximate the same paths where submarine fiber optic cable is laid on the ocean floor.

### BRIEF SUMMARY OF THE INVENTION

The present invention is a system of buoys, connected by vertical cables to submarine fiber optic communications cable on the ocean floor or in cases where no submarine fiber optic cable is present, the buoys will use satellite communication. The buoys are aligned on the surface of the ocean, underneath heavily traveled oceanic air routes to provide platforms for radios. The satellite or cable connection to the buoys enable high bandwidth communications backhaul from the buoy to the interne or public switched telephone network. The high bandwidth buoys provide a platform to put different radio systems, enabling a substantially uninterrupted radio connection to high altitude aircraft as they transit oceanic airspace.

### BRIEF DESCRIPTION OF THE SEVERAL VIEWS OF THE DRAWING

FIG. 1 is a side view of one buoy comprising part of the present invention;

FIG. 2 is a top view of one buoy comprising part of the present invention; and

FIG. 3 is a top system view of several buoys comprising part of the present invention.

FIG. 4 is a diagrammatical view of a system of buoys of this invention showing buoy positions along aircraft traffic in the North Atlantic Track System.

### DETAILED DESCRIPTION OF THE INVENTION

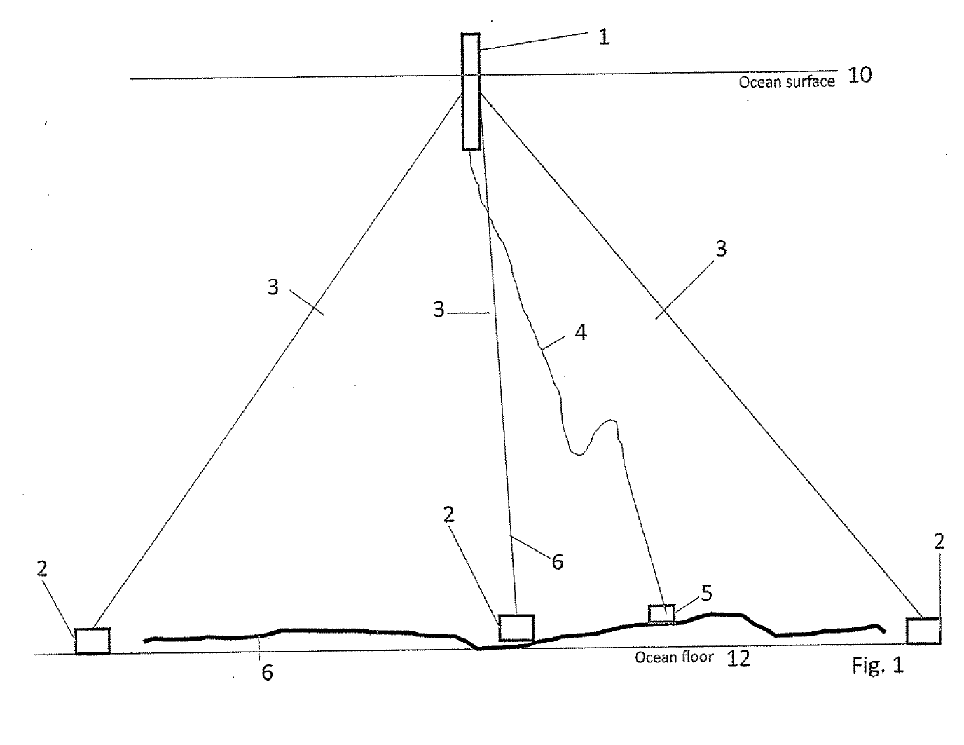

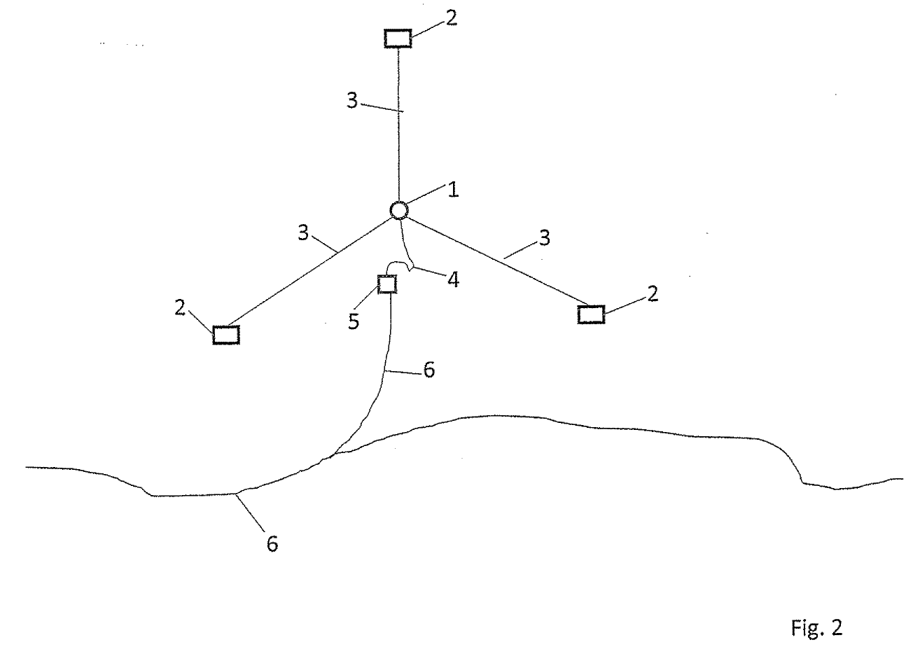

Referring now to the invention in more detail, in FIG. 1 and FIG. 2 there is shown a large buoy or structure 1 floating on the surface of the ocean 10 and attached to the ocean floor 12 by a combination of anchors 3 and mooring lines. 2. The buoy or structure 1 is also attached to an undersea junction box or branching unit 5 by a dynamic riser 4. The undersea junction box 5 is also attached to an undersea fiber optic cable system 6. When no fiber optic submarine cable is available, satellite communications will be used.

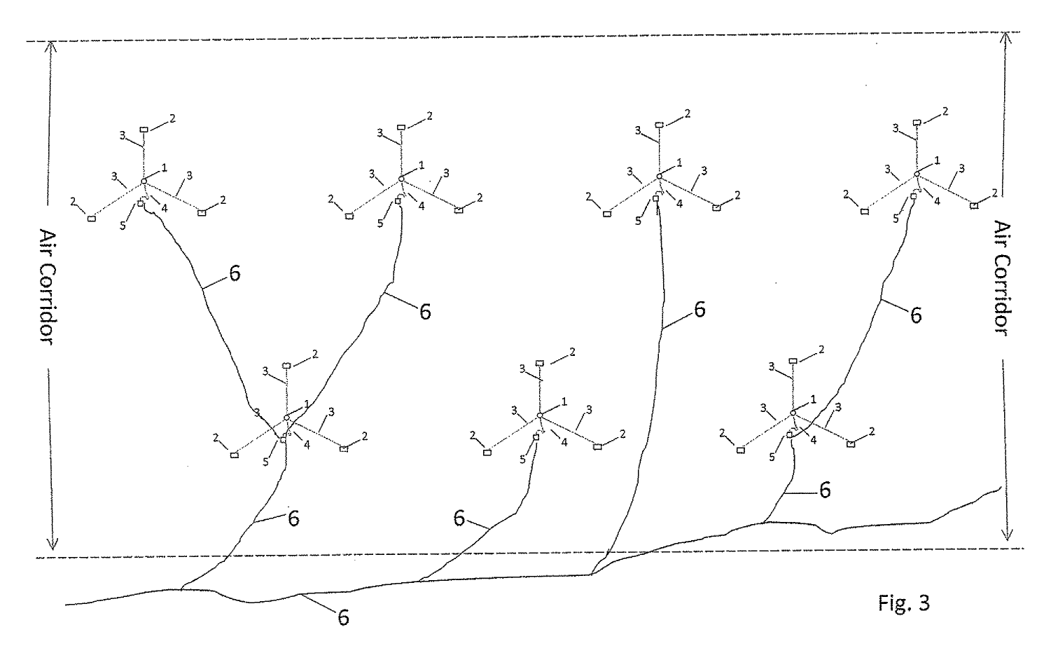

FIG. 3 depicts a Top System View of several large buoys or structures 1 moored in position by anchors 3 and mooring lines 2, and attached by dynamic risers 4 to the submarine junction box or branching unit 5 and to a submarine fiber optic cable system 6. When no fiber optic submarine cable is available, satellite communications will be used. The several large buoys or structures 1 are optimally positioned on the surface of the ocean under heavily traveled air routes.

In more detail, still referring to the invention of FIG. 1 and FIG. 2, the buoy or structure 1 contains electric generators, fuel, as well as equipment and wiring required to deliver wideband internet connectivity and electricity to voice and data radio systems. The large buoy or structure 1, functioning as a floating radio mast, is seaworthy and tall enough to provide line of sight connectivity in storm conditions to high altitude aircraft. The large buoy or structure 1 is constructed of long life marine grade materials like steel or concrete. Other suitable materials that can withstand the rigors of an ocean salt-water environment may be used. The buoy or structure 1 may also contain a satellite communications system.

Still referring to the invention in FIG. 1 and FIG. 2, the mooring lines 3 have sufficient length and strength to hold the buoy at the designated location on the surface of the ocean. The type of anchors 2 may vary based on sea floor composition and type. Deadweight anchors or suction pile anchors are two possibilities.

Still referring to the invention in FIG. 1 and FIG. 2, the dynamic riser 4 connects the buoy to the undersea junction box 5. The dynamic riser 4 is a vertical umbilical cable, extending through the water column, connecting the floating buoy or structure 1 to the undersea junction box 5 on the ocean floor 12. The dynamic riser 4 contains fiber optic cable, electrical cable, load bearing cable, and connectors spaced along its length. The connectors provide electrical power and bandwidth to oceanographic sensors or to autonomous underwater vehicles. The undersea junction box 5 contains electrical power connectors and fiber optic cable connectors that can provide power and bandwidth to undersea oceanographic sensors. When using a transoceanic undersea fiber optic cable 6 to provide an internet connection to the buoy or floating structure 1, undersea junction box 5 provides the interface from the undersea fiber optic cable 6 to the large buoy or structure 1. The undersea junction box 5 can be spliced directly into the undersea fiber optic cable system 6 or it can be some distance from the undersea fiber optic cable system 6 and connect to it via an industry standard branching unit on the undersea fiber optic cable system 6 with an extension fiber optic cable to the undersea junction box 5. If satellite communication is being used to provide an internet connection (no undersea fiber optic cable available), the undersea junction box 5, provides bandwidth to the oceanographic sensors via the dynamic riser 4 connection to the satellite communications system contained in the buoy.

Referring to the invention in FIG. 3, the buoy or structure 1, is a single part of a larger oceanic scale system depicted in FIG. 3. The buoys or structures 1 are aligned to overhead commercial air traffic routes or corridors and to a dedicated or existing undersea fiber optic cable system 6. When no fiber optic submarine cable is available, satellite communications will be used. Spacing between buoys is based on radio line of sight to the high altitude commercial air traffic.

In further detail, still referring to the invention in FIG. 1 and FIG. 2, the buoy or structure 1 is sufficiently large to be seaworthy and provide enough freeboard in the worst sea conditions, such as about 30 feet to 700 feet in length. The mooring lines 3 are typically between 5-10 times the water depth in length. For example, the average water depth in the North Atlantic is approximately 14,000 feet, so each mooring line 3 would be between 70,000 and 140,000 feet in length depending on operational requirements and weather and sea conditions. Referring to the system of buoys in FIG. 3, the buoys or structures 1 are spaced between 150-250 nautical miles apart and are aligned longitudinally with the commercial air routes overhead. Great circle routes are the shortest distance between two points on the surface of the earth. Since airliners will normally fly to the left or right of a great circle route based on high altitude winds, the buoys or structures 1 will also be placed 150-250 nautical miles apart axially along the commercial air route.

The advantages of the present invention include, without limitation, the ability to provide a constant radio connection to high altitude aircraft as they transit the ocean, as well as a location to install ocean floor sensors, ocean water column sensors, and ocean surface sensors to advance scientific knowledge and improve weather forecasting.

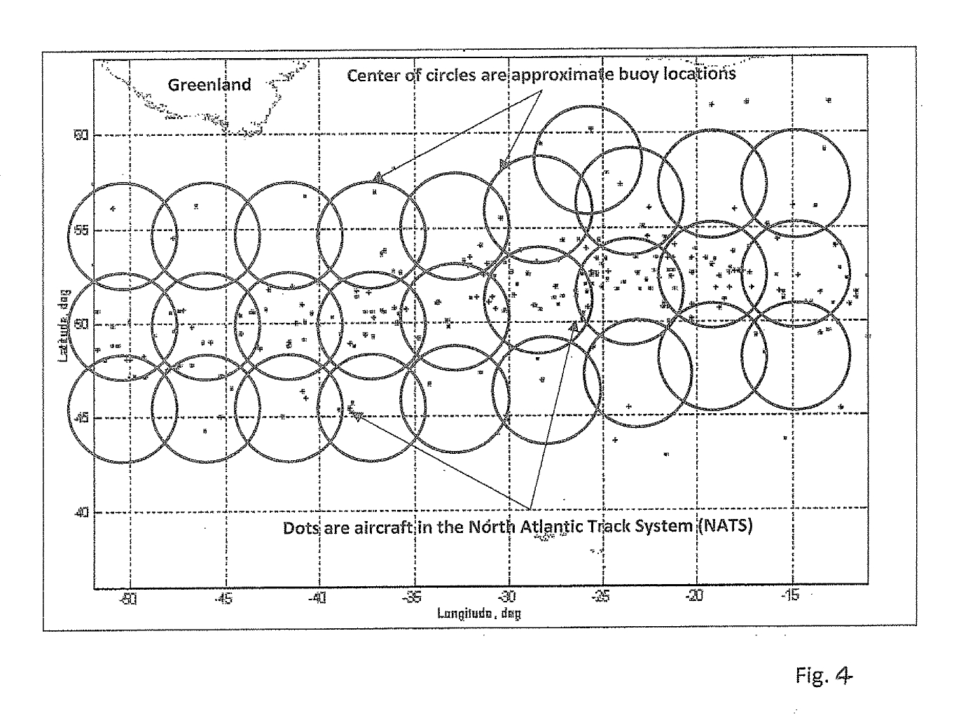

FIG. 4 illustrates a system or an array of buoys in the North Atlantic Track System. The buoys are located approximately in the center of the circles, the circle illustrating the communication range of each respective buoy. The communication range overlap of adjacent buoys is shown by the overlap of the circles. The dots along the North Atlantic Track System indicate aircraft. The overlap in range of the buoys provides a substantially continuous communication system to aircraft flying overhead.

1. An array of buoys positioned and retained at selected positions by being anchored to an ocean floor, the buoys being positioned at an ocean's surface, the array substantially traversing an ocean coextending with a commercial transoceanic flight path, the array providing a substantially continuous wireless signal to aircraft traveling along the commercial transoceanic flight path such that the buoys provide a substantially continuous communication system.

2. The array of buoys of claim 1 wherein the buoys have platforms for positioning receiver/transmitter devices.

3. The array of buoys of claim 2 wherein the receiver/transmitter devices comprise radios.

4. The array of buoys of claim 1 wherein fiber optic cables are positioned on the ocean floor, and the array of buoys further comprises a plurality of vertically extending cables, extending from the buoys to the fiber optic cables.

5. The array of buoys of claim 1 wherein the receiver/transmitter devices are in communication with communication satellites.

6. The array of buoys of claim 1 and further comprising at least one electrical generator positioned on at least one of the buoys to provide electrical power.

7. The array of buoys of claim 6 and further comprising at least one junction box or branching unit positioned below the ocean surface for providing electrical power below the ocean surface.

8. The array of buoys of claim 6 and further comprising at least one fiber optic cable connector in data communication with either a fiber optic cable on the ocean floor or in data communication with a satellite.

9. The array of buoys of claim 4 and further comprising at least one attachment point positioned on at least one of the vertical cables, the attachment point being positioned below the ocean's surface, the attachment point providing an electrical connection or a data communication connection below the ocean's surface.
